(19) United States
(12) Patent Application Publication
(10) Pub. No.: US 2010/0281427 A1
(43) Pub. Date: Nov. 4, 2010

(54) SELECTING ONE OF PLURAL USER PROFILE PERSONAE BASED ON CONTEXT

(76) Inventors: Riddhiman Ghosh, Sunnyvale, CA (US); Mohamed E. Dekhil, Santa Clara, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/432,904

(22) Filed: Apr. 30, 2009

(51) Int. Cl. G06F 3/048

(52) U.S. Cl. 715/811

(57) ABSTRACT

A context relating to a service accessed in response to a request responsive to user action is determined. Based on the determined context, at least one of plural, different user profile personae is selected. The selected at least one user profile persona contains information useable during access of the service.

### BACKGROUND

Users can electronically access services either online or offline. Electronically accessing services online refers to accessing services in a network environment, such as by visiting websites over the Internet to access services provided by such websites. Electronically accessing services offline refers to accessing services at physical locations associated with retail outlets or other establishments, such as by using kiosks.

When electronically accessing services, users often have to provide personal information about themselves. Having to enter personal information can be associated with various issues. First, it may be inconvenient for the user to have to enter personal information each time the user accesses a service. Moreover, in some cases, a user may have concerns relating to privacy or security of personal information submitted to a party that the user may not trust.

### BRIEF DESCRIPTION OF THE DRAWINGS

Some embodiments of the invention are described with respect to the following figures:

FIG. 1 is a schematic diagram of an exemplary arrangement in which an embodiment of the invention can be incorporated;

FIG. 2 is a flow diagram of a process of selectively using multiple user profile personae for accessing a service, according to an embodiment; and

FIG. 3 is a flow diagram of a process of selectively using multiple user profile personae for accessing a service, according to another embodiment.

### DETAILED DESCRIPTION

Users can use computers, personal digital assistants (PDAs), smartphones, or other types of electronic devices to electronically access services provided in an online environment, such as at websites available over the Internet. Moreover, electronic kiosks or other types of user interface systems are increasingly becoming available at various retail outlets or other establishments. For example, stores can provide kiosks to allow users to select items to purchase. Increasingly, airlines are providing kiosks at airports to allow travelers to check into their flights as well as to purchase other items.

When a user is accessing a service provided by a new service provider in which the user had not previously established a relationship, it is typical for the user to be prompted to enter various personal information about the user, including preferences and/or interests of the user. Having to enter the personal information of the user each time the user accesses a new service can be inconvenient. Moreover, when accessing a particular service, the user's preferences, interests, or other information may change based on the context of accessing the particular service. For example, the user may have different preferences depending upon whether the user is accessing the service at home or at work, or during the weekend or on a weekday. The user preferences may also change depending upon the purpose of the user in accessing the service. For example, the user may be accessing the service as a researcher as part of the user's work. Alternatively, the user may be accessing the service for the purpose of engaging in online electronic gaming. These different contexts or purposes when accessing a service are examples of different personae of a user associated with the service.

More generally, when accessing a service, depending on the context associated with access of the service, the user may wish to provide different user profile personae, which are different user profiles suited to represent the different personae of a user. A user profile persona is a structured construct that contains information both directly and indirectly pertaining to a user's preferences, interests, behavior, background, and other information. Multiple user profile personae of a user are typically related to each other, and may share common information as they all pertain to the same user.

In accordance with some embodiments, multiple user profile personae associated with the user are maintained such that different ones of the user profile personae are selected by a profile selection mechanism based on the context of accessing the particular service. Multiple user profile personae associated with a user can be described by corresponding different files, or they may be part of the same file with different sections describing the corresponding different profile personae.

One exemplary context is context based on day of the week. For example, if the user is accessing the service during the weekend, a first of the user profile personae may be selected for accessing the service. Alternatively, when the user is accessing the service during a week day, another one of the user profile personae can be selected for accessing the service.

As further examples, different user profile personae can be selected based on locations of the user. Moreover, different profile personae can be selected based on a current task being performed by the user. For example, from calendar information, it can be determined that during a particular time window, the user is in a meeting—if the profile selection mechanism according to some embodiments detects that the user is accessing a service during this time window, then the profile selection mechanism will attempt to select a user profile persona that may be relevant to the meeting to be used for accessing the service.

Also, information relating to the social network of a user may be used for selecting user profile personae. It can be determined that during particular times of the day, a user may frequently interact with other users online, such that any access of a service during such time periods may cause selection of a user profile persona that may be more relevant to the group of participants of the particular social network.

As yet another example, the profile selection mechanism may detect that the user is accessing a new service associated with a new service provider, which may indicate that the user may not trust this new service provider. In such a scenario, the profile selection mechanism will attempt to select a profile persona that contains a minimal amount of information about the user that the user is willing to share with such a service provider. As yet another alternative, a false profile persona can be provided that includes fake or false information for privacy reasons.

More generally, the context in which a user accesses a service impacts the user's behavior, preferences, and/or interests when accessing the service. The context includes the environment of the user (e.g., location of the user), time information, tasks being performed by the user, whether the service accessed is associated with a trusted or non-trusted service provider, a social network of the user, and so forth. A user may wear different hats and have different modes when interacting with a service.

Data relating to the multiple user profile personae may be maintained in a device associated with a user. For example, the device can be mobile device, such as a mobile telephone, a PDA, a notebook computer, or any other electronic device that can store such data relating to user profile personae. Alternatively, the data relating to the user profile personae can be maintained on a desktop computer that is used by the user for accessing services online. The user profile personae can be stored on storage media of the device associated with the user, or alternatively, the user profile personae can be maintained on storage media external to the device, where the device stores referential information that identifies the location(s) where the user profile personae are located. If stored at an external location, the user profile personae can be stored on a device connected to a network to allow for network access.

As yet another alternative, portions of user profile personae may be kept in the device, while remaining portions of the user profile personae may be kept at storage locations external to the device. For example, a user profile personae may include a summary section and a detailed section. The summary section can be kept on the device, while the detailed section can be kept external to the device to avoid consuming excessive storage resources of the device.

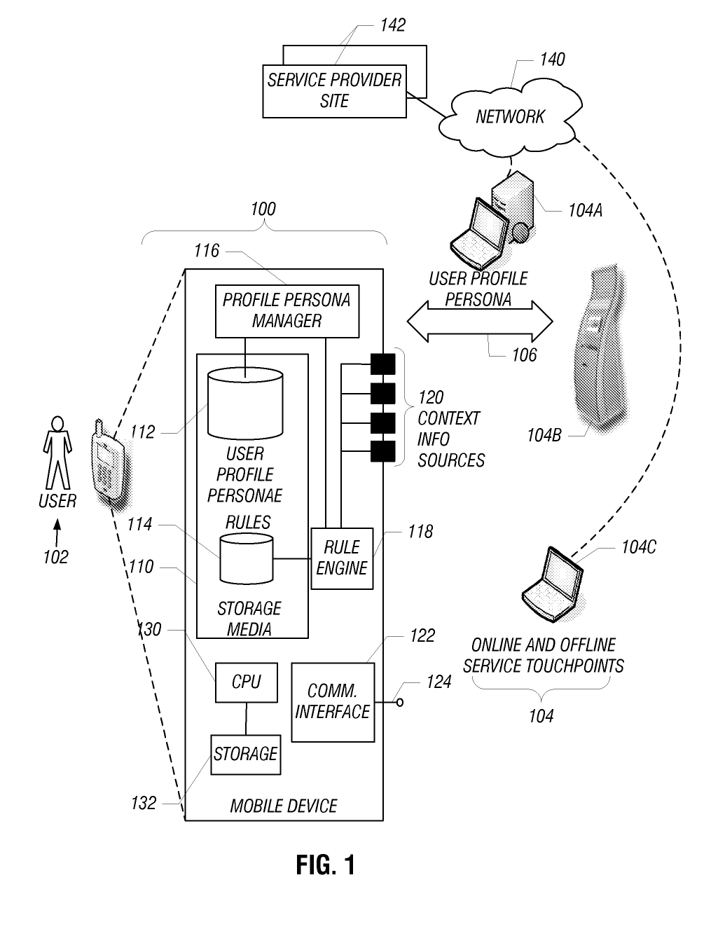

FIG. 1 illustrates an exemplary arrangement that includes a device 100 associated with a user 102. In the example of FIG. 1, the device is a mobile device, referred to as a personal mobile trusted device, since the device 100 is for personal use of a user 102 and is not typically accessible by other users without authorization by the user 102. Alternatively, the device 100 can be another type of electronic device.

FIG. 1 also illustrates various “touchpoints” 104, which are points of interaction with corresponding services. For example, a touchpoint may be a desktop computer 104A or a notebook computer 104C (or other type of electronic device) that the user 102 can use to access an online service. Alternatively, the touchpoint can be a kiosk 104B, typically located at retail outlets or other types of establishments, which the user 102 can use to access a service.

The online touchpoints 104A and 104C are coupled to a network 140 (e.g., Internet), to allow the touchpoints 104A and 104C to access service provider sites 142 that provide corresponding services.

Each of the touchpoints 104A-104C is able to communicate over a link 106 with the device 100. The link 106 may be a wireless link, such as a radio frequency (RF) link, an infrared (IR) link, a Bluetooth link, a proximity-based link, a wireless personal area network (PAN) link, or other type of wireless link. Alternatively, the link 106 can be a wired link, such as a USB (universal serial bus) link, or other type of wired link.

The device includes a storage media 110 (e.g., one or more disk-based storage devices, or one or more semiconductor storage devices, etc.), that can store user profile personae 112 and rules 114 for selecting which of the user profile personae 112 to use based on a determined context when accessing a service.

The device 100 further includes a profile persona manager 116 that interacts with a rule engine 118 for selecting one of the user profile personae 112 when the user accesses a service, based on context information provided by one or more context information sources 120. The context information sources 120 can include one or more sensors (e.g., sensors to detect a location of a user), a time clock, a calendar that lists the appointments associated with user, a task application that identifies tasks being performed by the user, a mechanism to detect a social network of the user, a mechanism to detect whether a service accessed is associated with an existing or new service provider, and so forth. The context information sources 120 provide context information to the rule engine 118. The context obtained from the context information sources 120 is used by the rule engine 118 to select one of the user profile personae 112 when the user 102 is accessing a service using a touchpoint 104. The selected user profile persona is then provided by the profile persona manager 116 to a touchpoint 104 over the link 106.

Note that the user profile personae 112 and rules 114, the profile persona manager 116, and rule engine 118 can also or alternatively be stored on the touchpoint 104A or 104C when the user is accessing services in an online environment. In such context, the device 100 does not have to be present to allow for selection of user profile personae based on context. As yet another alternative, the mobile device 100 can be the touchpoint, and a user can access a service over the network 140 through the mobile device 100. In this role as touchpoint, the mobile device 100 is able to communicate profile information to the service without an intermediary.

A sensor for determining a location of a user can be a GPS (global positioning system)-based sensor that uses GPS information to determine the location of a user. Alternatively, the sensor for indicating the location of the user can be a cell tower triangulation-based sensor that communicates with cell-based stations to triangulate a position of the user. Alternatively, the sensor for indicating the location of a user can be an RFID (radio frequency identifier) sensor that is able to communicate with RFID tags provided at various locations to indicate where the device 100 may be located. As yet another alternative, the sensor for indicating the location of the user can be a built-in camera of the device 100, where the built-in camera can acquire images or video of the environment in which the user is located, and based on such acquired images or video, determine a location or environment of the user.

In some embodiments, the user profile personae 112 can be expressed using machine-accessible semantics according to a predefined format. For example, the user profile personae 112 may be expressed using the standards from the Semantic Web, and using the standard web ontology language (OWL) and resource description framework (RDF). By using a predefined format to express the user profile personae, different service providers will be able to employ the information kept in the user profile personae 112. In other words, the multiple user personae can be interpreted and used across multiple services and service providers.

The user profile personae 112 can be created in any number of ways. For example, the user profile personae 112 can be aggregations of profiles already created elsewhere for the user. Alternatively, the profile persona manager 116 can create the user profile personae 112 based on information input by the user 102 as the user accesses various services over the network 140.

The rules 114 that are used by the rule engine 118 to select a user profile persona include contextual rules that select a contextually relevant user profile persona based on context information provided by the context information sources 120. The rules 114 can further include one or more of the following: simple IF-THEN conditional rules in which for a particular service a predetermined corresponding user profile persona is automatically selected; rules specifying that at least a subset of the user profile personae are to be presented to the user to allow the user to select a suitable user profile persona for accessing a particular service; rules specifying that past selections of user profile personae are to be used to decide which user profile persona to select for a particular service; and any combination of the above.

The rules can map one service to multiple user profile personae, and/or the rules can map multiple services to a single profile persona.

Once a user profile persona is selected, the user profile persona can be communicated to the touchpoint 104 at which the user is accessing the service. In one example use scenario, a user may log in to the touchpoint 104, where the login allows the device 100 to determine the service that is being sought by the user 102. For this service, the profile persona manager 116 initiates the user profile persona selection process, and causes the rule engine 118 to receive the context information for selecting one of the user profile personae 112. The selected user profile persona is communicated over the link 106 to the touchpoint 104, where the user profile persona is then provided to service provider software (which can be executed at the touchpoint 104 or at a location remote from the touchpoint 104) for customizing the service according to the information in the selected user profile persona.

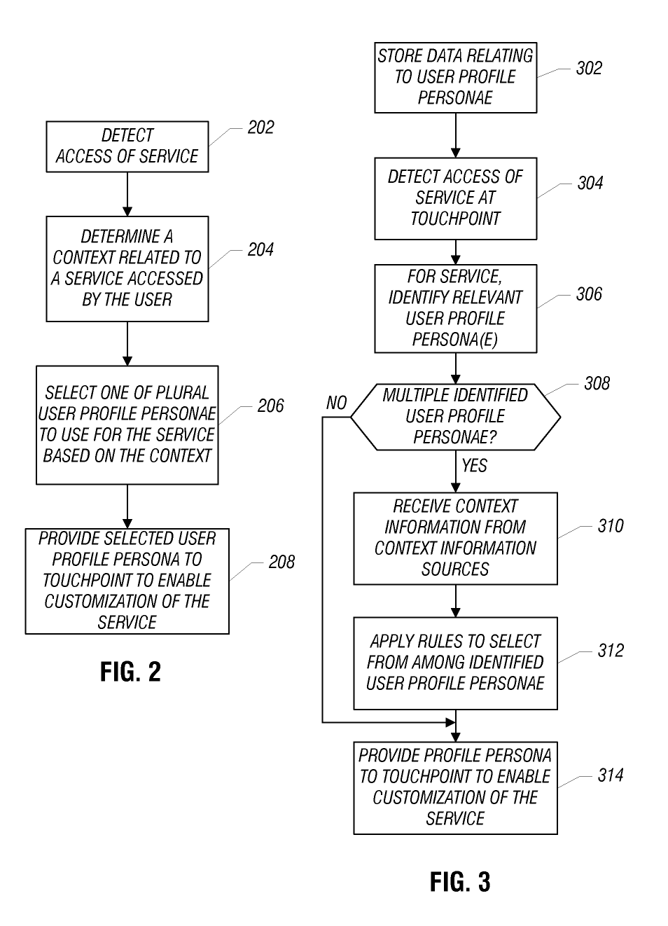

FIG. 2 is a flow diagram of a general process performed by the device 100 associated with a user 102. Note that the process of FIG. 2 can alternatively be performed by the touchpoint 104A or 104C in FIG. 1. Alternatively, note that the tasks of FIG. 2 can be performed by the device 100 that also acts as a touchpoint. The tasks of FIG. 2 can be performed by the profile persona manager 116 and/or rule engine 118 of FIG. 1. The device 100 detects (at 202) access of a service. For example, when a user logs into a touchpoint 104, the touchpoint 104 may be in communication with the device 100 to indicate that the user has successfully logged into the touchpoint 104 and is beginning to access the service. Such login can be detected by the profile persona manager 116. A user-initiated access of service is detected at the device 100 as a user service access request.

The device 100 then determines (at 204) a context related to a service access by the user. This context is determined based on context information provided by context information sources 120 (FIG. 1).

Next, the device 100 selects (at 206) one of the plural user profile personae to use for the service, based on the context. The selection of the plural user profile personae can be performed by the rule engine 118 of FIG. 1 based on the rules 114 and the context information from the context information sources 120.

Next, the selected user profile persona is provided (at 208) by the device 100 to the touchpoint 104 to enable customization of a service being accessed by the user.

In some cases, the rule engine 118 may select multiple user profile personae in response to the detected context. These multiple user profile personae may be considered to be the most relevant user profile personae for the detected context. In such cases, the profile persona manager 116 can perform an additional action to further select from among the multiple user profile personae. For example, the multiple user profile personae can be presented to the user, and the user can select which to use. Alternatively, the profile persona manager 116 can further apply other rules (in addition to the context-based rules), such as the IF-THEN conditional rules or the rule that selects a profile persona based on prior selection, as discussed above.

FIG. 3 illustrates a slightly more specific embodiment of the invention. The tasks of FIG. 3 can be performed by the profile persona manager 116 and/or rule engine 118. The device 100 stores (at 302) data relating to the user profile personae. The data stored may be the actual user profile personae themselves, or alternatively, the data can include just a portion of the user profile personae, or just referential information to allow locations of the user profile personae (external to the device 100) to be identified and accessed.

The device 100 detects (at 304) access of a service at a touchpoint. For example, the device 100 can perform short-range communications with a touchpoint, and for determining whether the user 102 associated with the device 100 is attempting to access a service through the touchpoint.

For the service that is being accessed, the device 100 identifies (at 306) relevant user profile persona(e). For a given service, there may be one or multiple user profile personae that are applicable, from a among all the stored user profile personae.

Next, the device 100 determines (at 308) if multiple user profile personae have been identified. If not, then the single user profile persona is provided (at 314) to the touchpoint to enable customization of the service based on the user profile persona. However, if it is determined (at 308) that multiple user profile personae have been identified, then the process proceeds to perform selection from among the multiple user profile personae. Context information from the context information sources is received (at 310) by the device 100. Then, rules 114 in the device 100 are applied (at 312) by the rule engine 118 to select from among the identified user profile personae. The selected profile persona is then provided (at 314) to the touchpoint to enable customization of the service.

Various benefits may be provided by some embodiments of the invention. From the perspective of the user, a more satisfying experience can be achieved when the user accesses a service, since the most relevant user profile persona is used to provide a customized service for the user. A user can also have flexibility to decide what information, preferences, and/or interests to reveal by deciding which user profile personae to activate for consideration by the profile persona manager 116 of FIG. 1. Also, privacy issues are addressed, since user profile personae exposed to potentially non-trusted services may contain less sensitive information.

Instructions of software described above (including the profile persona manager 116 and rule engine 118 of FIG. 1) are loaded for execution on a processor (such as one or more CPUs 130 in FIG. 1). The processor includes microprocessors, microcontrollers, processor modules or subsystems (including one or more microprocessors or microcontrollers), or other control or computing devices. As used here, a “processor” can refer to a single component or to plural components (e.g., one CPU or multiple CPUs).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method comprising:
determining, by a processor, a context relating to a service accessed in response to a request that is responsive to user action; and
selecting, by the processor based on the determined context, at least one of plural, different user profile personae, wherein the selected at least one user profile persona contains information useable during access of the service.

2. The method of claim 1, further comprising:
using the at least one user profile persona during access of the service, wherein the selected at least one user profile persona defines one or more of a user preference, user behavior, user interest, and user background.

3. The method of claim 1, further comprising:
storing data relating to the plural user profile personae in a device associated with a user.

4. The method of claim 3, wherein storing the data relating to the plural user profile personae comprises storing the data relating to the plural user profile personae in the device that is a mobile device carried by the user.

5. The method of claim 4, further comprising:
communicating, from the mobile device, the selected at least one user profile persona to an entity to allow customization of the service based on the selected at least one user profile persona.

6. The method of claim 3, wherein storing the data relating to the plural user profile personae comprises storing at least portions of the plural user profile personae on storage media of the device.

7. The method of claim 3, wherein storing the data relating to the plural user profile personae comprises storing referential information in storage media of the device, wherein the referential information points to one or more locations of at least portions of the plural user profile personae that are external to the device.

8. The method of claim 1, wherein determining the context comprises determining the context using one or more of the following:
one or more sensors of a device associated with a user;
information relating to an appointment of the user;
information relating to a task to be performed by the user;
information relating to a social network of the user; and
information relating to whether or not the service is associated with a trusted or non-trusted service provider.

9. The method of claim 8, wherein using the one or more sensors comprises any one or more sensors to detect a location of the user.

10. The method of claim 1, further comprising:
storing rules that specify criteria for selection from among the user profile personae; and
applying, by a rule engine, the rules to select the at least one user profile persona based on the determined context.

11. An apparatus comprising:
storage media to store data relating to plural, different user profile personae; and
a processor to:
obtain information to determine a context associated with access of a service in response to a request that is responsive to user action; and
according to the determined context, select one of the plural user profile personae to use in accessing the service.

12. The apparatus of claim 11, wherein the user profile personae have a predefined format recognizable by plural different types of services.

13. The apparatus of claim 11, wherein the storage media is to further store rules that map services to the user profile personae, wherein the rules are to perform one or both of the following mapping:
(1) map a particular one of the services to multiple ones of the plural user profile personae; and
(2) map multiple ones of the services to a particular one of the plural user profile personae.

14. The apparatus of claim 11, wherein the processor is to provide the selected profile persona to a service provider that provides the service to enable customizing of the service according to the selected user profile persona.

15. The apparatus of claim 14, further comprising a communications interface to communicate with a touchpoint to access the service, wherein the selected profile persona is provided through the communications interface.

16. The apparatus of claim 11, comprising a mobile device that includes the storage media and processor.

17. The apparatus of claim 11, further comprising at least one context information source selected from among
a sensor to sense an environment of a user;
calendar information relating to appointments of the user;
information relating to tasks of the user;
information relating to a social network of the user;
information relating to whether a service provider is a trusted or non-trusted service provider,
wherein the processor is configured to use the at least one context information source to determine the context.

18. An article comprising at least one machine-readable storage medium containing instructions that upon execution cause a device to:
detect access of a service in response to a request that is responsive to user action;
receive context information collected by one or more context information sources; and
apply rules based on the context information to select one or more of plural user profile personae to use in accessing the service.

19. The article of claim 18, wherein the instructions upon execution cause the device to further send the one or more plural user profile personae to an entity to enable customization of the service.

20. The article of claim 18, wherein the device is a mobile device having a communications interface to communicate with a touchpoint used to access the service.
